(19) United States
(12) Patent Application Publication
(10) Pub. No.: US 2009/0108834 A1
(43) Pub. Date: Apr. 30, 2009

(54) METHOD AND DEVICE FOR THE NON-CONTACT MEASUREMENT OF A DISPLACEMENT OF COMPONENTS RELATIVE TO ONE ANOTHER

(75) Inventor: Jorg KURTH, Meckenbeuren (DE)

Correspondence Address: DAVIS & BUJOLD, P.L.L.C., 112 PLEASANT STREET, CONCORD, NH, 03301, US

(73) Assignee: ZF Friedrichshafen AG, Friedrichshafen (DE)

(21) Appl. No.: 12/259,494

(22) Filed: Oct. 28, 2008

(30) Foreign Application Priority Data
Oct. 30, 2007 (DE) 10 2007 000 597.2

(51) Int. Cl. G01B 7/14

(52) U.S. Cl. 324/207.13

(57) ABSTRACT

A method and device for non-contact measurement of relative displacement (path difference) between a first component (2) and a second component (4), which are moving in an absolute sense to a structure that is fixed in position. The device includes a field barrier element (8, 10) arranged on each of the two components. These elements have structures that result in different magnetic permeation resistances at different relative overlaps. The field barrier elements project into a magnetic field that permeates them. A means (30) is associated with this magnetic field for determining the magnetic field strength that varies as a function of overlap of the field barrier elements and for evaluating the values determined.

This application claims priority from German Application Serial No. 10 2007 000 597.2 filed Oct. 30, 2007.

### FIELD OF THE INVENTION

The invention concerns a method for measuring displacement of components relative to one another without contact and a device for implementing the method.

### BACKGROUND OF THE INVENTION

Non-contact measurement methods and measurement devices are basically known. The sensors, used in such cases, generally work on the basis of magnetic or inductive functional principles, i.e., they measure the change of magnetic field strength or inductivity, brought about by the movement of a component relative to the positionally fixed sensor. The movement of the magnet detected by the sensor is evaluated in an evaluating unit and converted to a movement signal or movement display.

Such measurement methods and devices are entirely suitable for the determination of absolute displacements or rotations relative to a fixed structure. They are less suitable for determining a relative displacement (path difference) of a first component, relative to a second component which, for their part, undergo an absolute movement relative to a fixed structure. This technical task arises in the case of automated motor vehicle shift transmissions in which, for accurately controlling the function of a clutch and the shifting function, determination of relative movement of shift rods or relative rotation of transmission shafts is important.

From DE 197 26 696 A1, a rotation angle sensor is known, such that a change of a magnetic field occurring when a first component is rotated relative to a second one, is detected with the help of a Hall sensor and converted into a rotation angle value. As emerges from the context of the drawings and the description, in this case, the rotation of a permanent magnet, relative to a fixed yoke, is to be detected, such that by asymmetric magnetization of the permanent magnet, a measurement range longer than 180° is covered. The document in question describes the basic operating mode for non-contact measurement of the displacement of one component relative to another, but does not address the problem of measuring a relative displacement between two moved components, upon which the present invention is based.

Until now the path difference between two moved components could only be determined with the following arrangements:
a) determination of the absolute positions of the first component and the second component and calculation of the difference between the two values or
b) arrangement of an emitter element on one of the components and the sensor on the respective other component.

However, both methods or arrangements suffer from disadvantages, as explained below.

In the case of solution a) the accuracy of the system is reduced because the result is derived from the measurement of two absolute path sensors, whose measurement range has to cover the generally large measurement path of the two moved components. The accuracy that can be achieved is then less than in the case when one sensor only has to cover the relatively small measurement range of a relative movement, with a correspondingly higher resolution.

It is true that solution b) avoids this drawback of solution a) since the sensor, arranged on one of the components, only has to cover the smaller measurement range corresponding to the relative displacement. The disadvantage, however, is that the sensor signals from a moved component have to be transmitted to a fixed structure, and this makes it necessary either to carry along electric connection leads during the movement of the components or to provide sliding contacts, which when the movement frequency is high, can lead to problems of technical reliability in such arrangements (for example, breaking of the leads).

Against this background, the purpose of the present invention is to provide a simple and reliable method and device for the non-contact measurement of a relative displacement (path difference) of a first component relative to a fixed structure—generally in the same direction of movement.

### SUMMARY OF THE INVENTION

The invention is based on the recognition that the relative movement of the two components with respect to one another could also be used to vary the strength of a magnetic field that can be detected by a positionally fixed sensor.

Accordingly, the starting point of the invention is a method and device for the non-contact measurement of a relative displacement (path difference) of a first component relative to a second component, both of them moving relative to a fixed structure.

To achieve the stated objective, a method is provided in which field barrier elements, whose overlap differs as a function of the respective path difference, are provided on the components, which are permeated by an external magnetic field whose field strength varies as a function of the overlap of the field barrier elements and the magnetic field strength, in each case, is detected by a fixed sensor element associated with the field barrier elements and evaluated in an evaluation device.

With the method, the relative displacement of the two components can be determined by a sensor fixed in position so that no cables, carried along or sliding contacts, are needed. The sensor can be optimized for the smaller measurement range of the relative movement and does not have to cover the full measurement range of the moving components, which enable higher resolution and this greater accuracy of the measurement.

Let it be said at this point that the term “field barrier elements” stands for any type of elements arranged on the moving components and co-operating with one another, which have the ability to influence the magnetic field as a function of the relative position of the components with respect to one another and thus provide a path difference measure that can be detected by a sensor. The terms “overlapping” or “overlap” are here to be understood in the most general sense, i.e., meaning a mutual positioning of the field barrier elements that has a measurable influence on the magnetic field strength.

The device for implementing the method, described above, is characterized according to the present invention in that a field barrier element is arranged on each of the two movable components, these field barrier elements overlapping to a different extent as a function of the path difference in each case, the field barrier elements have a structure such that different relative overlaps produce different magnetic permeability resistances, the field barrier elements project into a magnetic field that permeates them, and means are provided for determining the magnetic field strength that varies as a function of the overlap between the field barrier elements and for evaluating the values determined.

The field barrier elements can consist of a material which offers a resistance to magnetic flux, the resistance varying as a function of the degree of overlap between the field barrier elements as will be explained in greater detail below.

To measure a relative displacement between two linearly moving components, it is provided that the field barrier elements are formed as bars, cables, strips or suchlike arranged substantially parallel to one another and to the movement plane of the components, which possess physical properties as described above enabling them to change the magnetic field strength. The field barrier elements are formed essentially as bars or cables or strips or suchlike with a series of perforations arranged at regular intervals in the movement direction, such that the relative measurement path of the field barrier elements is defined by a first end position in which the perforations of the two field barrier elements do not overlap, and by a second end position in which the perforations overlap completely. In the first end position, the two field barrier elements in combination form, as it were a closed wall which offers a comparatively high resistance to the magnetic flux so that the magnetic field strength detected by the sensor, is weak. In the second end position, the overlapping or superposed perforations allow the magnetic field to pass through, so the sensor measures a strong magnetic field.

A design feature of the field barrier elements provides that in the longitudinal direction, the bars, cables, strips or suchlike have serrations along the edge with regularly spaced teeth and gaps, such that by virtue of the relative displacement of the components, these bars, cables, strips or suchlike can move between a first end position in which the teeth of the two components are positioned “over gaps” and thus, in combination, form as it were a closed wall, and a second end position in which the teeth and gaps of the two bars, cables, strips or suchlike coincide and, therefore, allow the magnetic field to pass through.

To measure a relative rotation between two components rotating about a common longitudinal axis, for example two shafts, according to an embodiment of the invention, it is provided that the field barrier elements are formed as angular difference measurement wheels co-axial with one another, which change the magnetic field as a function of the relative rotation angle. In one design version of the invention, it is provided that the field barrier elements are formed as disks with regularly spaced perforations at the edge, such that the relative measurement path of the field barrier elements, is defined by a first end position in which the perforations of the two field barrier elements do not overlap and by a second end position in which the perforations overlap completely. According to a preferred design, the disks are serrated at the edge with regularly spaced teeth and gaps.

According to an embodiment of the invention, the magnetic circuit comprises a magnetic bridge that encompasses the field barrier elements like a stirrup and a sensor element arranged in a gap of the bridge to detect the strength of the magnetic field present therein. As shown by the description given above, the magnetic field strength that can be detected by the sensor element in the magnetic bridge depends on the relative position of the field barrier elements.

The magnetic bridge consists of a suitable ferromagnetic material and on at least one of its ends that encompass the field barrier elements, a permanent magnet that produces the magnetic field is preferably arranged.

As the sensor element, for example a Hall element, a magneto-resistive sensor, a coil with an iron core or suchlike can be used.

### BRIEF DESCRIPTION OF THE DRAWINGS

The invention will now be described, by way of example, with reference to the accompanying drawings in which:

FIG. 1 is a schematic longitudinal section of a measurement device for two shafts that can rotate relative to one another;

FIG. 2 is a schematic cross-section of a measurement device for two components that can move relative to one another, and

FIG. 3 is a diagram showing the magnetic flux density as a function of a relative displacement of the field barrier elements.

### DETAILED DESCRIPTION OF THE INVENTION

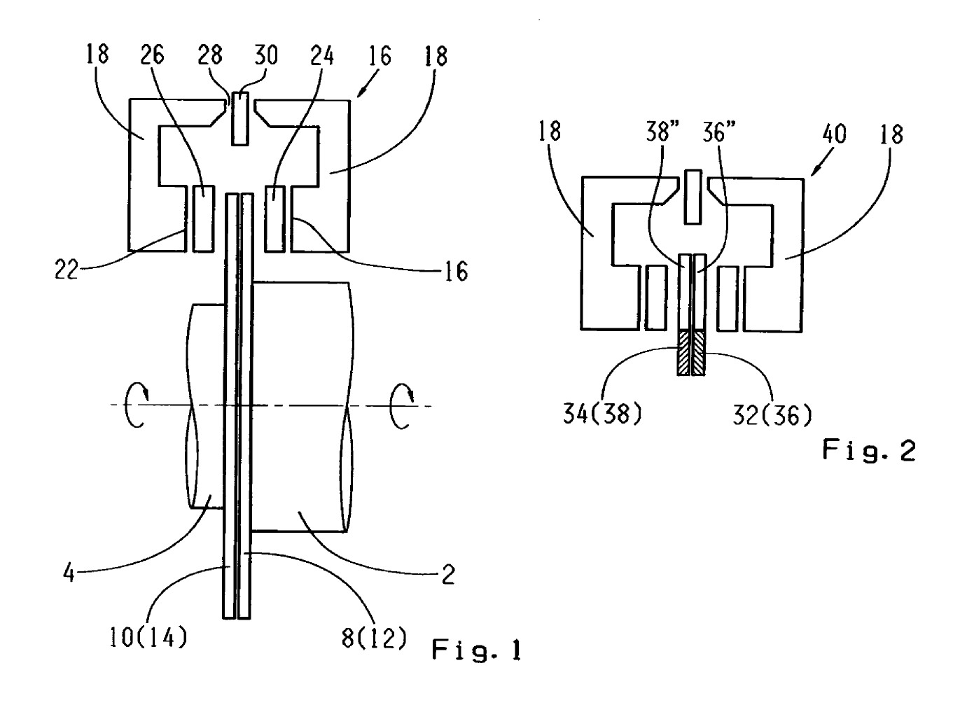

FIG. 1 shows a first shaft 2 and a second shaft 4, both mounted to rotate about a common rotation axis 6 in a positionally fixed structure (not shown) and which, during operation, both rotate in the same direction but at different speeds. To determine a relative rotation of the two shafts 2 and 4 with respect to one another, at the ends of these shafts, facing one another, are arranged disks 12 and 14 that function as field barrier elements 8 and 10, respectively, whose rotation, relative to one another, can be determined in a manner described below and evaluated in an evaluation unit (not shown).

Associated with the field barrier elements 8, 10 is a magnetic circuit arrangement 16, which produces a magnetic field that permeates the radially outer edge of the disks 12, 14. The magnetic field arrangement 16 comprises a magnetic bridge 18 which encompasses the edge of the field barrier elements like a stirrup, which is made from a ferromagnetic material and at whose ends 20 and 22 that embrace the field barrier elements 8, 10 these are arranged respective magnets 24 and 26. The magnets 24, 26 are preferably permanent magnets magnetized in the same direction.

In a gap 28 of the magnetic bridge 18, a sensor element 30 is arranged which detects the magnetic strength or magnetic flux in the magnetic circuit arrangement 16. The sensor element is connected to an electronic evaluation unit (not shown), which determines from the sensor element information, a relative rotation angle or a rotation speed difference, as will be described below.

The field barrier elements 8 and 10 each have a structure which results in different permeation resistances for the magnetic field produced by the magnetic circuit arrangement 16 and permeating through them when the relative rotation of the field barrier elements is different. Accordingly, by virtue of the variable magnetic field strength the sensor element 30 detects the varying rotation angle of the two field barrier elements 8, 10.

The field barrier elements 8, 10 shown in FIG. 1, are formed as disks 12, 14 which have in their edge area regularly spaced perforations which overlap to a greater or lesser extent depending on the relative rotation angle and so cause the permeation resistance for the magnetic field to vary.

Before a possible structure of the field barrier elements is described, with reference to FIG. 2, a device should be explained by way of a linear relative displacement of two components moving linearly can be measured. As shown by a comparison of FIGS. 1 and 2, the devices shown therein differ only in the structure of the field barrier elements. In FIG. 2, field barrier elements 32 and 34 are formed as flat, rectangular bars 36 and 38 or suchlike arranged substantially parallel to one another and to the movement plane of the components (not shown) which is perpendicular to the plane of the drawing. The field barrier elements 32, 34 again have a structure that results in different magnetic permeation resistances for the magnetic field produced by a magnetic circuit arrangement 40 and permeating the field barrier elements 32, 34 when the relative displacement varies. The magnetic circuit arrangement 40 is configured in the same way as the magnetic circuit arrangement 16 in FIG. 1, so there is no need to describe it in detail again.

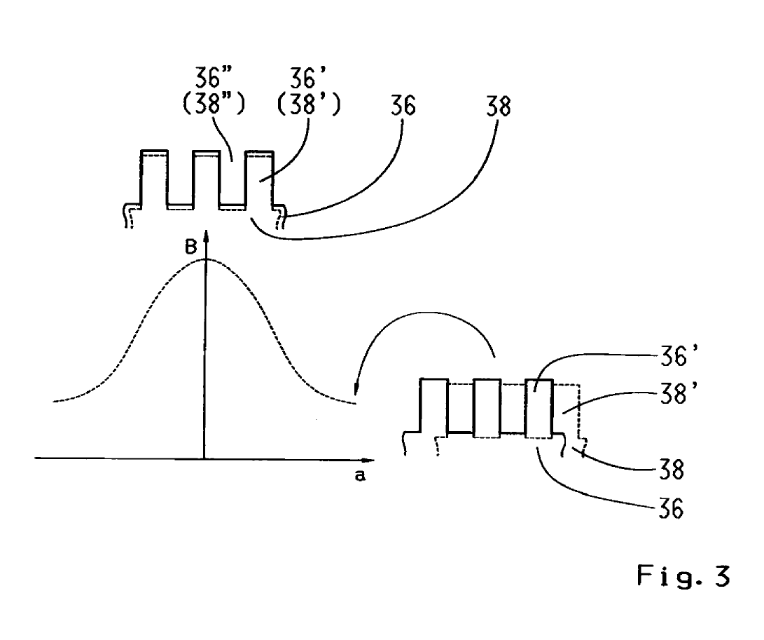

FIG. 3 shows an example of a possible structure of the field barrier elements 32, 34 in FIG. 2. The bars 36 and 38, forming the field barrier elements, are each provided in the area of their upper edge that projects into the magnetic field of the magnetic circuit arrangement 40, with an edge serration with regularly spaced teeth 36′ and 38′ and gaps 36″ and 38″, respectively. The gaps 36″ and 38″ are in an entirely general sense perforations, which can also have any other desired form, for example the shape of a window. The relative measurement path of the arrangement is designed such that it is defined by a first end position, shown on the right in FIG. 3, in which the perforations or gaps 36″, 38″ do not overlap, and by a second end position, shown at the top in FIG. 3, in which the perforations or gaps 36″, 38″ overlap completely.

As the diagram shown in FIG. 3 makes clear, the end position shown on the right in FIG. 3 corresponds to a situation in which the magnetic field strength B existing in the magnetic circuit arrangement 40 has its lowest value, whereas the second end position shown at the top of FIG. 3 corresponds to a situation in which the magnetic field strength B has its maximum value. In this way, each displacement position of the two rails 36, 38, relative to one another, is associated with a definite magnetic field strength B which can be converted by an evaluation unit into a displacement path a. Since the field barrier elements 32, 34 extend over the full absolute displacement path of the components, the respective magnetic field strength can be measured over this entire path. The sensor element 30, however, covers the small measurement range between the two relative end positions of the field barrier elements so that it has a high resolution and measurement accuracy.

In a manner similar to that shown in FIG. 2, the disks 12, 14, shown in FIG. 1, are formed in their edge areas with regularly spaced perforations or edge serrations, which make it possible to measure the relative rotation on angle of the two shafts 2, 4 with respect to one another, in a manner which need not be described in detail again.

### REFERENCE NUMERALS

2 first shaft
4 second shaft
6 rotation axis
8 field barrier element
10 field barrier element
12 disk
14 disk
16 magnetic circuit arrangement
18 magnetic bridge
20 end of the magnetic bridge
22 end of the magnetic bridge
24 magnet
26 magnet
28 perforation, gap
30 sensor element
32 field barrier element
34 field barrier element
36 bar
36′ teeth
36″ perforation, gap
38 bar
38′ teeth
38″ perforation, gap
40 magnetic circuit arrangement
A displacement path
B magnetic field strength

1-9. (canceled)

10. A method for non-contact measurement of relative displacement (path difference) of a first component relative to a second component which are moving relative to a structure that is fixed in position, the method comprising the steps of:
providing co-operating field barrier elements (8, 10) on the first component and the second component (shafts 2, 4) whose overlap varies as a function of the relative displacement;
permeating the field barrier elements (8, 10) by an external magnetic field whose field strength varies as a function of the overlap of the field barrier elements (8, 10);
determining the magnetic field strength, in each case, by a sensor element (30) associated with the field barrier elements (8, 10); and
evaluating the magnetic field strength with an evaluation unit.

11. A device for non-contact measurement of relative displacement (path difference) of a first component relative to a second component which are moving, in an absolute sense, relative to a structure that is fixed in position, the device comprising:
a field barrier element (8, 10) arranged on each of the first component (2) and the second component (4), whose overlap varies as a function of the relative displacement, each of the field barrier elements (8, 10) having a structure which results in different magnetic permeation resistances for different relative overlaps of the field barrier elements (8, 10), each of the field barrier elements (8, 10) being projected into a permeating magnetic field, and
a magnetic circuit arrangement (16) for determining the magnetic field strength that varies as a function of the overlap of the field barrier elements (8, 10) and evaluates values of the magnetic field strength obtained.

12. The device according to claim 11, wherein the field barrier elements (32, 34) are one of as bars, cables and strips (36, 38) that are substantially parallel to one another and to a movement plane of the first component (2) and the second component (4), with a series of gaps or perforations (36″, 38″) regularly spaced in a direction of movement, a relative measurement path of the field barrier elements (32, 34) is defined by a first end position in which the perforations of the field barrier elements do not overlap and by a second end position in which the perforations overlap completely.

13. The device according to claim 12, wherein the one of the bars, cables and strips (36, 38) are serrated, at an edge, with regularly spaced teeth (36′, 38) and gaps (36″, 38″).

14. The device according to claim 11, wherein the field barrier elements (8, 10) are coaxial disks (12, 14) having regularly spaced perforations or gaps in an edge area, the relative measurement path of the field barrier elements (8, 10) are defined by a first end position in which the perforations of the two field barrier elements do not overlap and by a second end position in which the perforations overlap completely.

15. The device according to claim 14, wherein the disks (12, 14) are serrated, at the edge area, with regularly spaced teeth and gaps.

16. The device according to claim 11, wherein the magnetic circuit arrangement (16) comprises a magnetic bridge (18) that encompasses the field barrier elements (8, 10) with a sensor element (30) in a gap of the bridge for determining the magnetic field strength (B) present therein.

17. The device according to claim 16, wherein the bridge (18) comprises a ferromagnetic material with a magnet (24, 26) arranged on at least one of end (20, 22) of the bridge (18) that encompasses the field barrier elements (8, 10).

18. The device according to claim 16, wherein the sensor element (30) is an element selected from a group comprising Hall elements, magneto-resistive sensors, and coils with iron cores.
